(19) United States
(12) Patent Application Publication
(10) Pub. No.: US 2013/0024553 A1
(43) Pub. Date: Jan. 24, 2013

(54) Location independent dynamic IP address assignment

(71) Applicants: Anuraag Mittal, San Jose, CA (US); Maithili Narasimha, Sunnyvale, CA (US); Munish Mehta, Fremont, CA (US); Srinivas Sardar, Fremont, CA (US)

(72) Inventors: Anuraag Mittal, San Jose, CA (US); Maithili Narasimha, Sunnyvale, CA (US); Munish Mehta, Fremont, CA (US); Srinivas Sardar, Fremont, CA (US)

(73) Assignee: CISCO TECHNOLOGY, INC., San Jose, CA (US)

(21) Appl. No.: 13/135,918

(22) Filed: Jul. 18, 2011

(51) Int. Cl. G06F 15/177

(52) U.S. Cl. 709/222

(57) ABSTRACT

In one embodiment, a method includes receiving at a network device operating as a relay agent, a Dynamic Host Configuration Protocol (DHCP) request from an end host, inserting a group identifier into the DHCP request and forwarding the DHCP request to a DHCP server, the end host associated with a group identified by the group identifier, receiving a response from the DHCP server, and forwarding the response to the end host. The response includes configuration information for the end host, at least some of the configuration information selected based on the group identifier. An apparatus is also disclosed.

### TECHNICAL FIELD

The present disclosure relates generally to communication networks, and more particularly, to IP (Internet Protocol) address allocation.

### BACKGROUND

In conventional IP networks, an end host IP address is used as a host identifier and a location identifier. This has simplified routing but has made mobility and multihoming more complicated. For example, when a host opens a TCP (Transmission Control Protocol) connection, the host identifies the remote end of the connection by the remote IP address and port. If the remote host changes its IP address mid-way (e.g., as a result of a virtual machine move across subnets or a roaming mobile device), the TCP connection will not survive since the transport layer identifier at the remote end of the connection is no longer the same.

### BRIEF DESCRIPTION OF THE DRAWINGS

FIG. 1 illustrates an example of a network in which embodiments described herein may be implemented.

FIG. 2 illustrates an example of a relay agent at a virtual switch in communication with a virtual machine.

FIG. 3 illustrates an example of the relay agent at a network device in communication with a mobile device.

FIG. 4 depicts an example of a network device useful in implementing embodiments described herein.

FIG. 5 is a flowchart illustrating an overview of a process for location independent dynamic IP address assignment, in accordance with one embodiment.

FIG. 6 illustrates an example of a sub-option in a packet transmitted from a relay agent to a DHCP server in the network of FIG. 1, in accordance with one embodiment.

Corresponding reference characters indicate corresponding parts throughout the several views of the drawings.

### DESCRIPTION OF EXAMPLE EMBODIMENTS

Overview

In one embodiment, a method generally comprises receiving at a network device operating as a relay agent, a Dynamic Host Configuration Protocol (DHCP) request from an end host, inserting a group identifier into the DHCP request and forwarding the DHCP request to a DHCP server, the end host associated with a group identified by the group identifier, receiving a response from the DHCP server, and forwarding the response to the end host. The response comprises configuration information for the end host, at least some of the configuration information selected based on the group identifier.

In another embodiment, an apparatus generally comprises a relay agent for receiving a Dynamic Host Configuration Protocol (DHCP) request from an end host associated with a group identified by a group identifier, inserting the group identifier into the DHCP request, forwarding the DHCP request to a DHCP server, receiving a response from the DHCP server, and forwarding the response to the end host. The apparatus further comprises memory for storing the group identifier. The response comprises configuration information for the end host, at least some of the configuration information selected based on the group identifier.

Example Embodiments

The following description is presented to enable one of ordinary skill in the art to make and use the embodiments. Descriptions of specific embodiments and applications are provided only as examples, and various modifications will be readily apparent to those skilled in the art. The general principles described herein may be applied to other applications without departing from the scope of the embodiments. Thus, the embodiments are not to be limited to those shown, but are to be accorded the widest scope consistent with the principles and features described herein. For purpose of clarity, details relating to technical material that is known in the technical fields related to the embodiments have not been described in detail.

In networks, such as data centers, VDI (virtual desktop infrastructure) deployments, cloud infrastructures, and mobile networks, end client mobility is an important and desired property. One of the enabling technologies for achieving mobility is the use of disjoint route locators and end host identifiers (e.g., as proposed in HIP (Host Identity Protocol) and LISP (Locator Identifier Separation Protocol)). HIP uses IP addresses purely as route locators and proposes using 128-bit ORCHIDs (Overlay Routable Cryptographic Hash Identifiers) as end host identifiers. LISP uses end host IP addresses purely as host identifiers.

When an end client moves across subnets (e.g., virtual machine moves from one host to another host in a different subnet), even though LISP takes care of routing to the new location, problems arise when the host needs to renew its IP address. This may be as a result of an impending lease expiry, for example. In conventional networks, a DHCP (Dynamic Host Configuration Protocol) server will automatically assign a new address from the range assigned to the new subnet if there is no subnet specified in the request. This jeopardizes existing TCP (Transmission Control Protocol) connections since the end host IP address is no longer the same. In order for the end host to obtain an IP address from a subnet that is different from the relay agent's subnet, the end host needs to specify a subnet in the request. In conventional networks, there is no efficient mechanism to dynamically provision IP addresses from a single pool or configure other policy parameters for a group of end hosts that need to be uniformly administered and managed irrespective of their actual geographical locations. It is desired to keep mobile devices and virtual machines in the same subnet regardless of their mobility or the underlying physical hosts (for virtual machines).

The embodiments described herein simplify IP address allocation and management in environments that use layer 3 mobility and rely on DHCP for IP assignment. The embodiments may be implemented, for example, in settings wherein DHCP is used to auto configure IP addresses for end hosts. The DHCP servers become mobility aware while the end hosts are essentially mobility unaware. The embodiments provide a simplified configuration at the DHCP server and prevent IP address flapping when clients move across subnets, therefore helping existing TCP sessions. The end hosts can retain their IP addresses and request the same address even after moving to different physical hosts across subnets. The DHCP server may also allocate other policy parameters uniformly to all clients belonging to the same group. There is no change required to the end host stack.

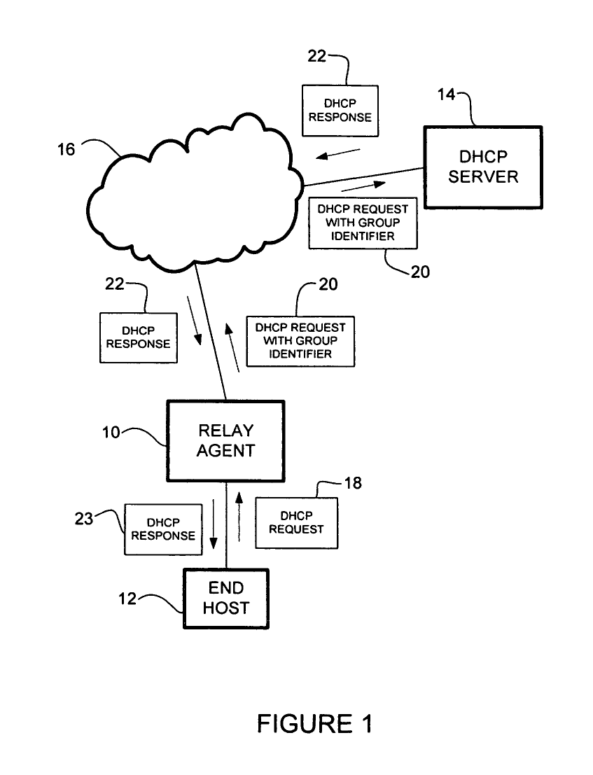

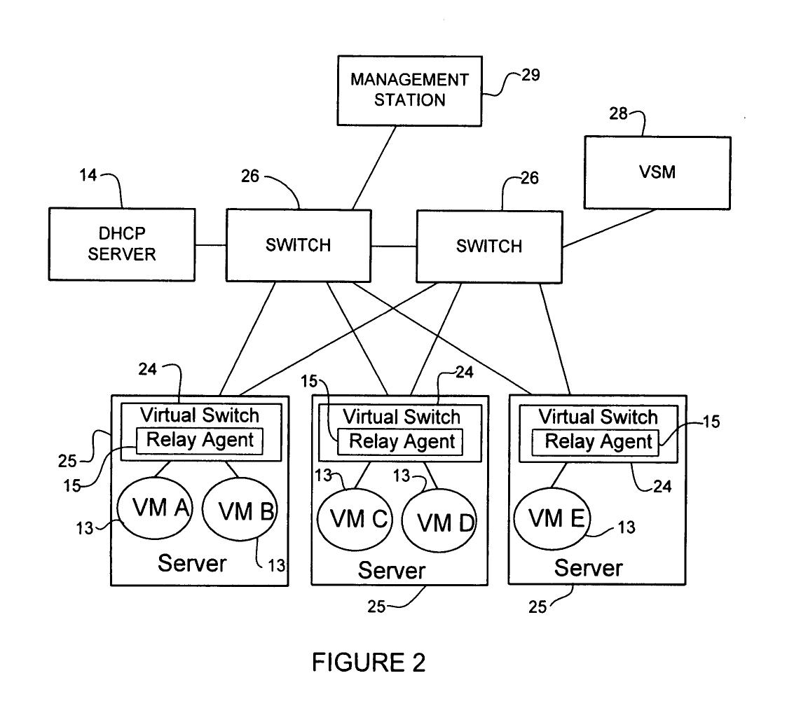

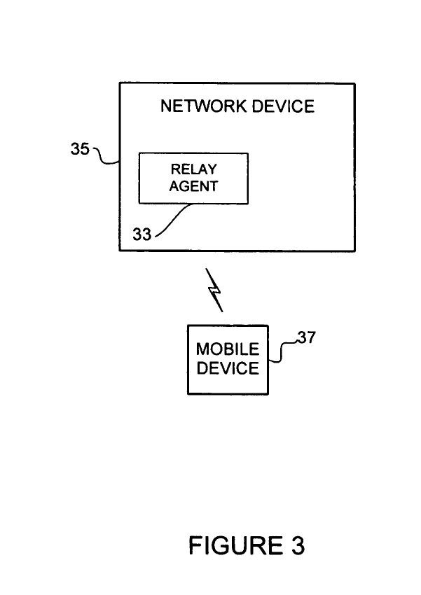

The embodiments described herein operate in the context of a data communication system including multiple network elements (nodes). Referring now to the drawings, and first to FIG. 1, an example of a network in which embodiments described herein may be implemented is shown. The network may be configured for use as a data center or any other type of network. For simplification, only a small number of nodes are shown. The communication system includes a relay agent 10 in communication with an end host (end client) 12 and a DHCP server 14 through a network 16. The network 16 may include any number of network devices, including switches, routers, gateways, management stations, appliances, etc. The end host 12 may belong to the same subnet or a different subnet than the relay agent 10. The end host may be, for example, a virtual machine located on a physical host (FIG. 2) or a mobile device (FIG. 3). The relay agent 10 may be located at a network device such as a virtual switch on a host (FIG. 2), wireless access point (FIG. 3), physical switch, router, or any other network device operable to perform relay functions.

When the end host 12 connects to the network 16, it sends a broadcast query (DHCP request 18) requesting necessary information from the DHCP server 14. As described in detail below, when the relay agent 10 receives the DHCP request 18, it inserts a group identifier assigned to the end host 12. The group identifier identifies the end host 12 as being part of a group. The group may be, for example, a group of end hosts associated with a common set of policies or an organization, or a type of end host. The group may include, for example, LISP clients. The DHCP server 14 assigns policies and IP addresses based on the group identifier.

As shown in FIG. 1, the relay agent 10 forwards request 20 with the group identifier to the DHCP server 14. The DHCP server 14 includes a sub-block definition for each of the group identifiers that it has to service and uses this information when responding to client requests. The DHCP server 14 manages a pool of IP addresses and other configuration information about the client such as default gateway, domain name, name servers, etc. Upon receiving the request 20, the server 14 assigns the end host 12 an IP address and other IP configuration parameters. The DHCP server 14 is configured to recognize the group identifier and may use this information when assigning an IP address or other policy parameters. The DHCP server 14 echoes the group identifier back to the relay agent in a DHCP response 22. The relay agent 10 strips the group identifier before forwarding response 23 to the end host 12.

In one embodiment, the above functionality is introduced through a virtual switch 24 that resides in the physical host hosting a virtual machine (end host) 13 (FIG. 2). Virtualization allows one computer to do the job of multiple computers by sharing the resources of a single computer across multiple systems. Software is used to virtualize hardware resources of a computer, including, for example, the CPU (central processing unit), RAM (random access memory), hard disk, and network controller, to create a virtual machine that can run its own operating system and applications. Multiple virtual machines share hardware resources without interfering with each other so that several operating systems and applications can run at the same time on a single computer. Virtual machines may be used, for example, in a virtual infrastructure to dynamically map physical resources to business needs.

As shown in FIG. 2, the relay agent 15 resides in virtual switch 24 at server 25, which also contains one or more virtual machines 13. In one embodiment, the virtual switch comprises a distributed virtual switch including a virtual switch component (referred to herein as a Virtual Ethernet Module (VEM)) 24 installed at the server 25 and a Virtual Supervisor Module (VSM) 28. The VSM 28 may be located in a physical appliance (e.g., server) in communication with the servers 25 via physical switches 26, or the VSM may be a virtual appliance (e.g., virtual machine) installed at one of the servers 25 or another server in the network. The physical switches 26 are also in communication with the DHCP server 14 and may be in communication with a management station 29 (e.g., virtualization management platform such as VMware Virtual Center management station, available from VMware of Palo Alto, Calif.).

The VSM 28 is configured to provide control plane functionality for the virtual machines 13. The virtual switch 24 provides switching capability at the server 25 and operates as a data plane associated with the control plane of the VSM 28. The VSM 28 and virtual switch (VEM) 24 operate together to form a distributed virtual switch as viewed by the management station 29. It is to be understood that the distributed virtual switch shown in FIG. 2 and described herein is only an example and that other virtual switches may be used without departing from the scope of the embodiments.

In the example shown in FIG. 2, each server 25 includes a virtual switch (VEM) 24 and one or more virtual machines (VM A, VM B, VM C, VM D, VM E) 13. VM A and VM B are located on a first server, VM C and VM D are located on a second server, and VM E is located on a third server, each server being physically separate from the other servers. A virtual machine monitor such as hypervisor (not shown) dynamically allocates hardware resources to the virtual machines 13. The virtual machines 13 may be moved (referred to as vMotion) between servers 25 and across subnets, based on traffic patterns, hardware resources, or other criteria (e.g., layer 3 move).

The virtual machines 13 are in communication with the virtual switch 24 via virtual network interface cards (VNICs) which connect to a virtual Ethernet interface at the virtual switch. The server 25 includes an Ethernet port for each physical network interface card. The Ethernet ports may be aggregated at a port channel. The virtual switches 24 are in communication with the network via the physical Ethernet interfaces. The virtual switch 24 switches traffic between the virtual machines and the physical network interface cards.

The group identifier may be configured by a network administrator as part of a port profile configuration that is applied when the end host joins the network (e.g., virtual machine instantiated on a physical host). The port profile is a container used to define a common set of configuration policies (attributes) for multiple interfaces. The port profiles are associated with port configuration policies defined by the network administrator and applied automatically to a large number of ports as they come online in a virtual environment. The network administrator may, for example, assign a port profile, which has a group tag configured on it, to a virtual Ethernet port connected to the virtual machine 13. A port profile name may also be used as a group tag.

FIG. 3 illustrates an example of a relay agent 33 operating at a network device 35 in communication with a mobile device (end host) 37. The relay agent 33 is also in communication with DHCP server 14, as shown in FIG. 1. There may be any number of network devices in the path between the relay agent 33 and DHCP server. For simplification, only one network device 35 and mobile device 37 are shown in FIG. 3. The network device 35 may be, for example, an access point in wireless communication with the mobile device 37. The network device 35 may also be a physical switch or other device in communication with the mobile device 37 via an access point or any other network device. The mobile device 37 may be, for example, a phone, personal digital assistant, laptop, tablet, or other device. The mobile device 37 may also be configured for wired communication (e.g., connected to a docking station).

The mobile device 37 moves between a set of network devices 35 configured to identify the mobile device as belonging to a particular group. The network device 35 may identify the mobile device 37 as belonging to a particular group based on information exchanged between the mobile device and network device when the mobile device connects to the network device, or by virtue of how and where the mobile device connects to the network. For example, the group may be identified based on a MAC (media access control) address of the mobile device 37, through IEEE 802.1X (port based network access control), SSID (service set identifier) (e.g., which local area network the device connects), or other means.

It is to be understood that the networks shown in FIGS. 1, 2, and 3 are only examples and that the embodiments described herein may be implemented in networks having different network topologies and network devices, without departing from the scope of the embodiments. For example, the relay agent may operate at any network device (e.g., virtual switch at host, physical switch (e.g., access switch), router, wireless controller, access point, etc.) configured to perform relay operations.

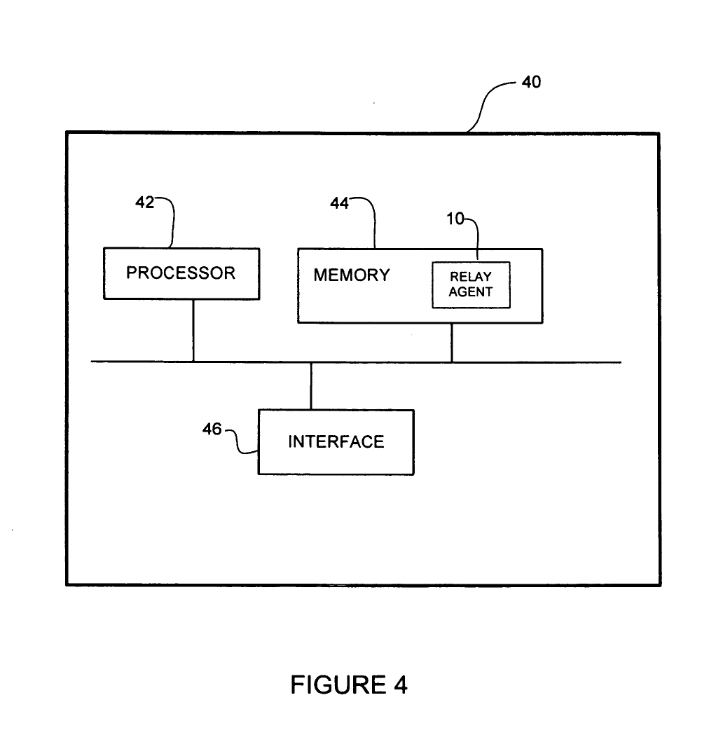

An example of a network device 40 that may be used to implement embodiments described herein is shown in FIG. 4. In one embodiment, network device 40 is a programmable machine that may be implemented in hardware, software, or any combination thereof. The device 40 includes one or more processors 42, memory 44, and network interface 46. Memory 44 may be a volatile memory or non-volatile storage, which stores various applications, modules, and data for execution and use by the processor 42. For example, memory 44 may include components configured for performing relay agent 10 operations.

Logic may be encoded in one or more tangible computer readable media for execution by the processor 42. For example, the processor 42 may execute codes stored in a computer readable medium such as memory 44. The computer readable medium may be, for example, electronic (e.g., RAM (random access memory), ROM (read-only memory), EPROM (erasable programmable read-only memory)), magnetic, optical (e.g., CD, DVD), electromagnetic, semiconductor technology, or any other suitable medium.

The network interface 46 may comprise one or more interfaces (linecards, ports) for receiving data or transmitting data to other devices. The interface 46 may include, for example, an Ethernet interface for connection to a computer or network.

It is to be understood that the network device shown in FIG. 4 and described above is only an example and that network devices having different components and configurations may be used without departing from the scope of the embodiments.

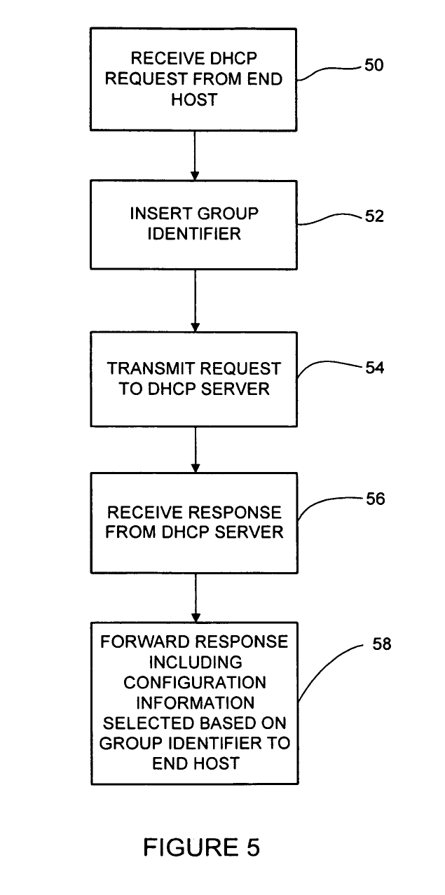

FIG. 5 is a flowchart illustrating an overview of a process for location independent dynamic IP address assignment, in accordance with one embodiment. When the end host is first initialized or joins the network, it sends a DHCP request packet 18 (FIG. 1). The relay agent 10 receives the DHCP request from the end host 12 at step 50 (FIG. 5). The relay agent 10 modifies the client's DHCP request by inserting the relay agent's address (e.g., in a gateway IP address field) and the group identifier (e.g., in a sub-option of a relay agent information option described below) (step 52). The request packet 20 is transmitted from the relay agent 10 to the DHCP server 14 (step 54). The DHCP server 14 uses the group identifier in assigning IP addresses or other policy parameters. For example, the DHCP server 14 may allocate an IP address to the end host 12 from one of the pools of addresses it has available for the specified group. The DHCP server 14 sends this information along with the group identifier to the relay agent 10. The relay agent 10 receives response packet 22 from the DHCP server 14 (step 56). The response 22 includes configuration information (e.g., IP address, policies, etc.), at least some of which is selected based on the group identifier. The relay agent 10 removes the group identifier from the packet and forwards the response 23 to the end host 12 (step 58).

If the DHCP server is not configured to recognize the group identifier, it will ignore this information and will not echo it back to the relay agent 10. In this case, the DHCP server may assign an IP address from a subnet corresponding to the relay agent's IP address, for example.

It is to be understood that the process illustrated in FIG. 5 and described above is only an example and that steps may be modified, added, or combined, without departing from the scope of the embodiments.

The DHCP request packet 20 comprises a number of fields, including, for example, Op (specifies generally type of message (e.g., request, reply)), Htype (hardware type), Hlen (hardware address length), Hops (used by relay agent to control forwarding), XID (transaction identifier), Secs (time elapsed), Flags, Addresses (client address, your address, server address, gateway address (GIADDR) (contains relay agent address)), client hardware address, and options. One or more of the options may be used to identify the vendor and functionality of the DHCP client. In one embodiment, the options include a relay agent information option that contains any number of sub-options used to convey information known by the relay agent, including the group identifier. The sub-option may be, for example, a sub-option of the relay agent information option 82, as described in IETF (Internet Engineering Task Force) RFC (Request for Comments) 3046 (“DHCP Relay Agent Information Option”, M. Patrick, January 2001).

The sub-options may include, for example, a circuit ID which identifies the circuit connecting the end host to the relay agent, and a remote ID, which identifies the relay agent. These two sub-options help to identify individual end hosts, but do not identify a group that the client belongs. Another sub-option is used to identify the group to which the end host 12 belongs. In addition to using the group identifier in address assignment, the DHCP server may also use the group identifier in assigning other server options, class options, etc. The group identifier simplifies configuration of DHCP servers by providing uniform policies and provisioning uniform pools of IP addresses for each of these groups of end nodes. The group identifier may also be interpreted differently by different DHCP servers, if required. These benefits are not provided by the first two sub-options.

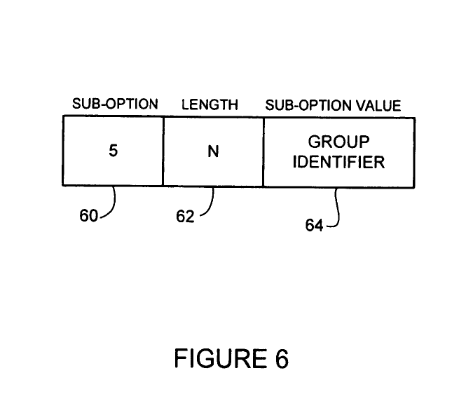

FIG. 6 illustrates an example of a sub-option in DHCP request 20 used to transmit the group identifier. The sub-option includes a sub-option number field (e.g., number 5) 60, length field (N) 62 (provides the total number of octets in the sub-option value field), and sub-option value field 64, which contains the group identifier (tag). It is to be understood that the format shown in FIG. 6 is only an example, and that other fields or formats may be used to transmit the group identifier, without departing from the scope of the embodiments.

Although the method and apparatus have been described in accordance with the embodiments shown, one of ordinary skill in the art will readily recognize that there could be variations made without departing from the scope of the embodiments. Accordingly, it is intended that all matter contained in the above description and shown in the accompanying drawings shall be interpreted as illustrative and not in a limiting sense.

What is claimed is:

1. A method comprising:
receiving at network device operating as a relay agent, a Dynamic Host Configuration Protocol (DHCP) request from an end host;
inserting a group identifier into the DHCP request and forwarding the DHCP request to a DHCP server, the end host associated with a group identified by said group identifier;
receiving a response from the DHCP server, the response comprising configuration information for the end host, at least some of said configuration information selected based on said group identifier; and
forwarding the response to the end host.

2. The method of claim 1 wherein said configuration information comprises an Internet Protocol (IP) address.

3. The method of claim 2 wherein said IP address is selected from a pool of IP addresses assigned to a group of end hosts.

4. The method of claim 1 wherein said configuration information comprises one or more policies.

5. The method of claim 1 further comprising inserting an address of the relay agent into the DHCP request.

6. The method of claim 1 wherein said group identifier is inserted in a relay agent option in the DHCP request.

7. The method of claim 1 wherein said group identifier identifies a group of end hosts associated with a common set of policies.

8. An apparatus comprising:
a relay agent for receiving a Dynamic Host Configuration Protocol (DHCP) request from an end host associated with a group identified by a group identifier, inserting said group identifier into the DHCP request, forwarding the DHCP request to a DHCP server, receiving a response from the DHCP server, and forwarding the response to the end host; and
memory for storing said group identifier;
wherein the response comprises configuration information for the end host, at least some of said configuration information selected based on said group identifier.

9. The apparatus of claim 8 wherein said configuration information comprises an Internet Protocol (IP) address.

10. The apparatus of claim 9 wherein said IP address is selected from a pool of IP addresses assigned to a group of end hosts.

11. The apparatus of claim 8 wherein said configuration information comprises one or more policies.

12. The apparatus of claim 8 wherein said group identifier is inserted in a relay agent option in the DHCP request.

13. The apparatus of claim 8 wherein the end host comprises a mobile device.

14. The apparatus of claim 8 wherein the relay agent operates at a virtual switch and the end host comprises a virtual machine.

15. Logic encoded on one or more tangible computer readable media for execution and when executed operable to:
process at a relay agent, a Dynamic Host Configuration Protocol (DHCP) request from an end host;
insert a group identifier into the DHCP request and forward the DHCP request to a DHCP server, the end host associated with a group identified by said group identifier; and
forward to the end host, a response received from the DHCP server, the response comprising configuration information for the end host, at least some of said configuration information selected based on said group identifier.

16. The logic of claim 15 wherein said configuration information comprises an Internet Protocol (IP) address.

17. The logic of claim 16 wherein said IP address is selected from a pool of IP addresses assigned to a group of end hosts.

18. The logic of claim 15 wherein said configuration information comprises one or more policies.

19. The logic of claim 15 wherein the end host comprises a mobile device.

20. The logic of claim 15 wherein the relay agent operates at a virtual switch and the end host comprises a virtual machine.
